(19) United States
(12) Patent Application Publication
(10) Pub. No.: US 2007/0043968 A1
(43) Pub. Date: Feb. 22, 2007

(54) Disk array rebuild disruption resumption handling method and system

(75) Inventor: Chih-Wei Chen, Taipei (TW)

Correspondence Address: BIRCH STEWART KOLASCH & BIRCH, PO BOX 747, FALLS CHURCH, VA, 22040-0747, US

(73) Assignee: INVENTEC CORPORATION

(21) Appl. No.: 11/205,153

(22) Filed: Aug. 17, 2005

(51) Int. Cl. G06F 11/00

(52) U.S. Cl. 714/6

(57) ABSTRACT

A disk array rebuild disruption resumption handling method and system is proposed, which is designed for use with a disk array unit for providing the disk array unit a rebuild disruption resumption handling function, and which is characterized by the capability of continually recording a set of identification data about each block that has completed rebuild and storing the recorded data as disruption point data in a specified permanent storage area, so that in the event of an unexpected disruption to the rebuild procedure, the recorded disruption point data allows the resumed rebuilding procedure to be started from the disruption point. This feature allows the resumed rebuilding procedure after a power failure disruption to be more efficiently carried out, thus making the overall network management work more efficient than prior art.

### BACKGROUND OF THE INVENTION

1. Field of the Invention

This invention relates to information technology (IT), and more particularly, to a disk array rebuild disruption resumption handling method and system which is designed for use in conjunction with a disk array unit, such as a RAID (Redundant Array of Independent Disks), for providing the RAID unit with a rebuild disruption resumption handling function that allows an unexpectedly-disrupted rebuild procedure on the RAID unit, such as due to power failure, to be later resumed from the disruption point rather than from the beginning point as in the case of prior art.

2. Description of Related Art

RAID (Redundant Array of Independent Disks) is a multi-disk storage unit that contains two or more hard disks for providing a very large data storage capacity. A RAID unit is commonly connected in a network system to one or more servers for these servers to store the large amount of data that flow through the network system. Since a RAID unit contains a cluster of independent disks, it allows an interleaved access method that can significantly enhance data access speed, as well as providing a multiple backup function that allows the storage of data to be highly reliable and secured.

In actual applications, the multiple disks on a RAID unit are divided into active disks and backup disks, where the active disks are assigned to be used to store data during normal operation of the network system, whereas in the event of a failure to any one of the active disks, the backup disks can be used to perform a rebuild procedure for the failed active disk, whereby all the data that were previously stored on the failed active disk are rebuilt on the backup disk. In practical implementation, RAID utilizes a specific block called “superblock” in its storage space for the storage of a set of attribute and configuration data about each disk on the RAID unit, where these data are used to indicate, for example, whether the associated disk is used as an active disk or a backup disk, whether a failure has occurred to the associated disk, whether the associated disk is a rebuilt one, to name just a few.

In practical applications, however, a RAID rebuild procedure might be disrupted without warning halfway during the session due to unexpected conditions, such as power failure. In this case, when electrical power resumes and the network management personnel restarts the rebuild procedure, the restarted rebuild procedure will start all over again from the beginning point, and not from the disruption point. For this sake, if a rebuild procedure is disrupted due to power failure, all of the previously rebuilt data blocks will be gone. Since a rebuild procedure takes quite a long period of time to complete and requires much computing power from the server platform, the traditional rebuild method is undoubtedly very time-consuming and inefficient.

### SUMMARY OF THE INVENTION

It is therefore an objective of this invention to provide a disk array rebuild disruption resumption handling method and system which allows an unexpectedly-disrupted RAID rebuild procedure, such as due to power failure, to be later resumed from the disruption point rather than from the beginning point as in the case of prior art.

It is another objective of this invention to provide a disk array rebuild disruption resumption handling method and system which allows high efficiency in network management for RAID.

The disk array rebuild disruption resumption handling method and system according to the invention is designed for use in conjunction with a disk array unit, such as a RAID (Redundant Array of Independent Disks), for providing the RAID unit with a rebuild disruption resumption handling function that allows an unexpectedly-disrupted rebuild procedure on the RAID unit, such as due to power failure, to be later resumed from the disruption point rather than from the beginning point as in the case of prior art.

The disk array rebuild disruption resumption handling method according to the invention comprises: (1) in the event of a rebuild procedure being carried out on a disk on the disk array unit, recording a set of identification data about each block that has completed rebuilding and storing the recorded data as a set of disruption point data in a specified permanent storage area such that in the event of power failure, the stored disruption point data is non-volatile; (2) responding to a rebuild resumption request event initiated after an event of unexpected disruption to the rebuild procedure, if any, on the disk array unit, by retrieving the disruption point data from the permanent storage area for use to determine the disruption point in the previous rebuild procedure that has been disrupted; and (3) performing a resumed rebuilding procedure on the rebuilding disk in the disk array unit that starts from the disruption point in the previous rebuild procedure.

In terms of architecture, the disk array rebuild disruption resumption handling system according to the invention comprises: (a) a disruption point recording module, which is capable of being activated in the event of a rebuild procedure being carried out on a disk on the disk array unit to record a set of identification data about each block that has completed rebuilding, and further capable of storing the recorded data as a set of disruption point data in a specified permanent storage area such that in the event of power failure, the stored disruption point data is non-volatile; (b) a disruption point retrieval module, which is capable of responding to a rebuild resumption request event initiated after an event of unexpected disruption to the rebuild procedure, if any, on the disk array unit, by retrieving the disruption point data from the permanent storage area for use to determine the disruption point in the previous rebuild procedure that has been disrupted; and (c) a rebuilding module, which is capable of performing a resumed rebuilding procedure on the rebuilding disk in the disk array unit that starts from the disruption point in the previous rebuild procedure.

The disk array rebuild disruption resumption handling method and system according to the invention is characterized by the capability of continually recording a set of identification data about each block that has completed rebuild and storing the recorded data as a set of disruption point data in a specified permanent storage area, such as a superblock on each disk of the RAID unit, so that in the event of an unexpected disruption to the rebuild procedure, the resumed rebuilding procedure can be started from the disruption point, and not all over again from the beginning point as in the case of prior art. This feature allows the resumed rebuilding procedure after a power failure disruption to be more efficiently carried out, thus making the overall network management work more efficient than prior art.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the application architecture and modularized object-oriented component model of the disk array rebuild disruption resumption handling system according to the invention; and

FIG. 2 is a schematic diagram showing an example of a superblock on each disk where disruption point data are stored on a RAID unit.

### DETAILED DESCRIPTION OF PREFERRED EMBODIMENTS

The disk array rebuild disruption resumption handling method and system according to the invention is disclosed in full details by way of preferred embodiments in the following with reference to the accompanying drawings.

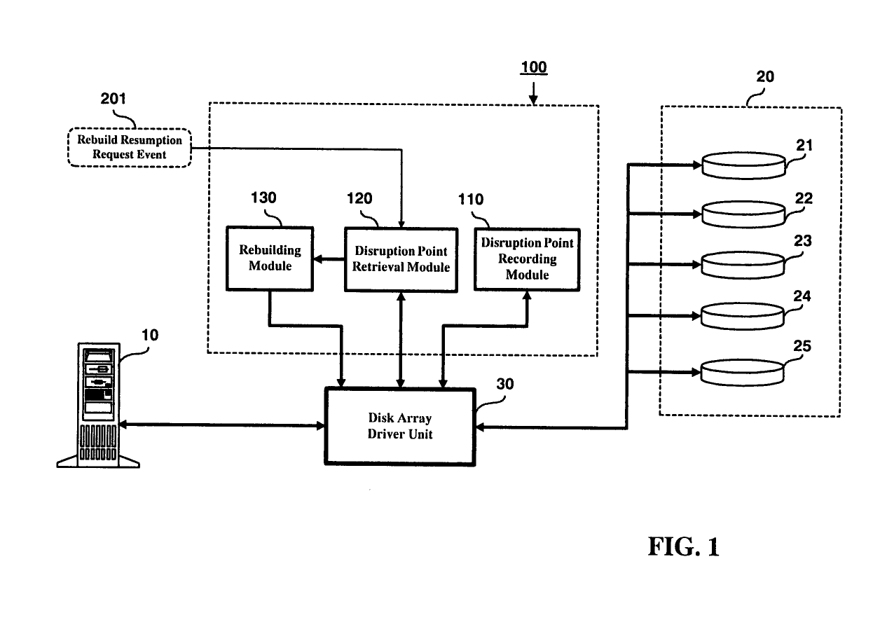

FIG. 1 is a schematic diagram showing the application architecture and modularized object-oriented component model of the disk array rebuild disruption resumption handling system according to the invention (as the part enclosed in the dotted box indicated by the reference numeral 100). As shown, the disk array rebuild disruption resumption handling system of the invention 100 is designed for use in conjunction with a computer platform, such as a network server 10, that is connected via a disk array driver unit 30 to a disk array unit, such as a RAID (Redundant Array of Independent Disks) unit 20, for providing the RAID unit 20 with a rebuild disruption resumption handling function that allows an unexpectedly-disrupted rebuild procedure on the RAID unit 20, such as due to power failure, to be resumed from the disruption point when power resumes or the RAID unit 20 is removed to another server (not shown).

In the embodiment of FIG. 1, it is assumed that the RAID unit 20 includes 5 independent disks 21, 22, 23, 24, 25, wherein the first four independent disks 21, 22, 23, 24 are used as active disks, while the last disk 25 is used as a backup disk. It is to be noted that in the example of FIG. 1, the RAID unit 20 contains only 5 independent disks; but in practice, the RAID unit 20 may contain much more disks.

As shown in FIG. 1, the modularized object-oriented component model of the disk array rebuild disruption resumption handling system of the invention 100 comprises: (a) a disruption point recording module 110; (b) a disruption point retrieval module 120; and (c) a rebuilding module 130. In practical implementation, for example, the disk array rebuild disruption resumption handling system of the invention 100 can be fully realized by computer code which is integrated as an add-on software or firmware module to the operating system of the server 10 or the driver program of the RAID unit 20.

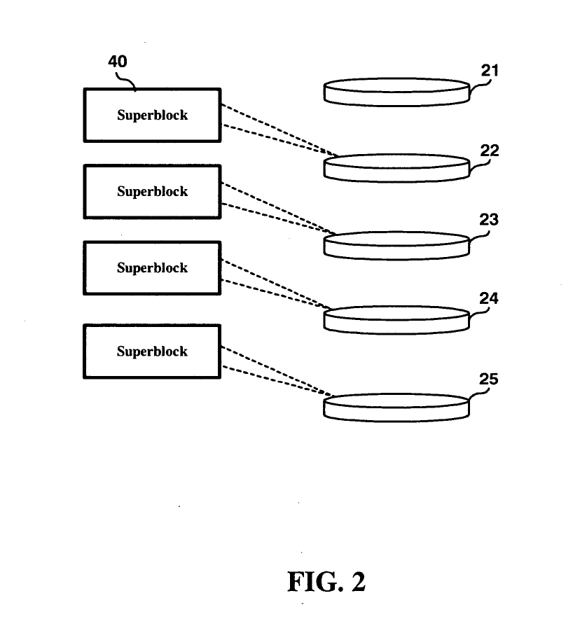

The disruption point recording module 110 is capable of being activated in the event of a rebuild procedure being performed on the backup disk 25 for a failed one of the active disks (for example the first disk 21) on the RAID unit 20 to record a set of identification data about each block that has completed rebuilding, i.e., promptly after a block or a cluster of blocks have completed rebuilding, the index numbers of these blocks are recorded. The recorded identification data will be later utilized to determine the disruption point of the rebuild procedure, and which are stored in a specified permanent storage area, such as a flash memory in the server 10, or a prespecific block in any of the other disks 22, 23, 24, 25. The latter scheme is the best mode embodiment of the invention, since by storing the disruption point data in other disks 22, 23, 24, 25, it allows the RAID unit 20 to be removed to another server platform (not shown) to resume the rebuild procedure there and allows the other server platform to gain access to the disruption point data directly from the RAID unit 20. As shown in FIG. 2, in this best mode embodiment, for example, the disruption point data (i.e., index numbers of rebuilt blocks) are written to a specified block, such as a superblock 40, in any one of the other disks 22, 23, 24, 25, where the superblock 40 is typically used to store the RAID's configuration data.

The disruption point retrieval module 120 is capable of being activated in response to a rebuild resumption request event 201 initiated after an event of unexpected disruption (such as power failure) to a previous rebuild procedure on the RAID unit 20 to gain access to and retrieve the disruption point data recorded by the foregoing disruption point recording module 110 in the event of a disruption to the previous rebuild procedure. The retrieved disruption point data is used to determine the index numbers of unrebuilt blocks in the backup disk 25. In this embodiment, since the disruption point recording module 110 stores the disruption point data to a superblock 40 in each of the other disks 22, 23, 24, 25 on the RAID unit 20, the disruption point retrieval module 120 will activate the disk array driver unit 30 to retrieve the needed disruption point data from the superblock 40.

The rebuilding module 130 is capable of performing a resumed rebuilding procedure on the backup disk 25 in the RAID unit 20 by starting from the disruption point in the backup disk 25, i.e., from the first of the unrebuilt blocks. For example, if the disruption point data indicates that the index number of the last block that has completed rebuilding before the disruption occurred is “31”, then the resumed rebuilding procedure will start from the block with the index number “32”. In practical implementation, the resumed rebuilding procedure performed by this rebuilding module 130 should includes an initial step of cache and write buffer status checking procedure that checks whether the cache memory and write buffer (not shown) on the RAID unit 20 is currently under active operating status; and if YES, the cache memory and the write buffer are temporarily disabled for the purpose of ensuring that the rebuild data can be reliably written onto the backup disk 25 without loss. After the resumed rebuilding procedure on the backup disk 25 is completed, the cache and write buffer status is reset to the same previous active operating status prior to the start of the resumed rebuilding procedure.

In the following description of an example of a practical application of the invention, it is assumed that the RAID unit 20 contains 5 independent disks 21, 22, 23, 24, 25, wherein the first four independent disks 21, 22, 23, 24 are used as active disks, while the last disk 25 is used as a backup disk; and further assumed that a failure occurs to the first active disks 21, such that the disk array driver unit 30 is activated to use the backup disk 25 to perform a rebuild procedure for the failed first active disks 21, but during this rebuild procedure, an unexpended power failure occurs to the server 10 such that the rebuild procedure is disrupted.

Referring to FIG. 1 together with FIG. 2, under the above-mentioned condition, when the rebuild procedure is started, the disruption point recording module 110 is activated to record a set of identification data about each block that has completed rebuilding, i.e., promptly after a block or a cluster of blocks have completed rebuilding, the index numbers of these rebuilt blocks are recorded. The recorded identification data are then stored as disruption point data in a specified permanent storage area, such as the superblock 40 in each of the other disks 22, 23, 24, 25 as shown in FIG. 2. If the rebuild procedure proceeds smoothly without being undisputed to the ending point, i.e., without power failure or other causes of disruption during the entire session, the disruption point data stored on the superblock 40 will be erased after the rebuild procedure is completed; whereas if the rebuild procedure is disrupted due to power failure or other causes, the data about the disruption point (i.e., the index numbers of rebuilt blocks) will be permanently stored on the superblock 40 of each of the other disks 22, 23, 24, 25.

When power is resumed to the server 10 (or the RAID unit 20 is removed to another server with normal power supply), the disruption point retrieval module 120 in the disk array rebuild disruption resumption handling system of the invention 100 will respond to a rebuild resumption request event 201 (i.e., when the network management personnel wants the previous disrupted rebuild procedure to be resumed on the RAID unit 20) by retrieving the disruption point data stored on the superblock 40 of each of the disks 22, 23, 24, 25. From the retrieved disruption point data, the index number of the last block that has completed rebuilding in the previous rebuild procedure can be checked, and based on which, the index number of the first of the unrebuilt blocks can be determined. The index number of the first one of the unrebuilt blocks is then transferred to the rebuilding module 130 to request the rebuilding module 130 to perform a resumed rebuilding procedure on the backup disk 25 by starting from the first of the remaining unrebuilt blocks. Before actually performing the resumed rebuilding procedure, the rebuilding module 130 will first perform an initial step of cache and write buffer status checking procedure that checks whether the cache memory and write buffer (not shown) on the RAID unit 20 is currently under active operating status; if YES, the cache memory and the write buffer are temporarily disabled for the purpose of ensuring the rebuild data can be assuredly written onto the backup disk 25 on the RAID unit 20. Assume the disruption point data indicates that the index number of the last block that completes rebuilding before the disruption occurred is “31”, then the resumed rebuilding procedure will start from the block of index number “32”.

During the resumed rebuilding procedure, the disruption point recording module 110 will be again activated to perform a disruption point recording function to record the index number of each rebuilt block, such that if power failure occurs once again during this resumed rebuilding procedure, the disruption point can be recorded into the RAID unit 20 for use in the subsequently resumed rebuilding procedure. This action is repeated until all the blocks in the failed active disks 21 have been rebuilt on the backup disk 25.

In conclusion, the invention provides a disk array rebuild disruption resumption handling method and system for use with a disk array unit, such as a RAID unit, for providing the RAID unit with a rebuild disruption resumption handling function, which is characterized by the capability of continually recording a set of identification data about each block that has completed rebuild and storing the recorded data as a set of disruption point data in a specified permanent storage area, such as a superblock on each disk of the RAID unit, so that in the event of an unexpected disruption to the rebuild procedure, the resumed rebuilding procedure can be started from the disruption point, and not all over again from the beginning point as in the case of prior art. This feature allows the resumed rebuilding procedure after a power failure disruption to be more efficiently carried out, thus making the overall network management work more efficient than prior art. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A disk array rebuild disruption resumption handling method for use on a disk array unit composed of a number of disks for providing the disk array unit with a rebuild disruption resumption handling function;
the disk array rebuild disruption resumption handling method comprising:
in the event of a rebuild procedure being carried out on a disk on the disk array unit, recording a set of identification data about each block that has completed rebuilding and storing the recorded data as a set of disruption point data in a specified permanent storage area such that in the event of power failure, the stored disruption point data is non-volatile;
responding to a rebuild resumption request event initiated after an event of unexpected disruption to the rebuild procedure, if any, on the disk array unit, by retrieving the disruption point data from the permanent storage area for use to determine the disruption point in the previous rebuild procedure that has been disrupted; and
performing a resumed rebuilding procedure on the rebuilding disk in the disk array unit that starts from the disruption point in the previous rebuild procedure.

2. The disk array rebuild disruption resumption handling method of claim 1, wherein the disk array unit is a RAID (Redundant Array of Independent Disks) unit.

3. The disk array rebuild disruption resumption handling method of claim 1, wherein the specified permanent storage for storing disruption point data is a superblock on an unfailed disk on the disk array unit.

4. The disk array rebuild disruption resumption handling method of claim 1, wherein the disruption point data recorded by the disruption point recording module includes an index number of the last block that has completed rebuilding in the previous rebuild procedure.

5. The disk array rebuild disruption resumption handling method of claim 1, wherein the resumed rebuilding procedure includes an initial step of cache and write buffer status checking procedure that checks whether the cache memory and write buffer operating status on the disk array unit is currently under active operating status; and if YES, the cache memory and the write buffer are temporarily disabled; and after the rebuild procedure on the backup disk is completed, the cache and write buffer status is reset to the previous active operating status.

6. A disk array rebuild disruption resumption handling system for use with a disk array unit composed of a number of disks for providing the disk array unit with a rebuild disruption resumption handling function;
the disk array rebuild disruption resumption handling system comprising:
a disruption point recording module, which is capable of being activated in the event of a rebuild procedure being carried out on a disk on the disk array unit to record a set of identification data about each block that has completed rebuilding, and further capable of storing the recorded data as a set of disruption point data in a specified permanent storage area such that in the event of power failure, the stored disruption point data is non-volatile;
a disruption point retrieval module, which is capable of responding to a rebuild resumption request event initiated after an event of unexpected disruption to the rebuild procedure, if any, on the disk array unit, by retrieving the disruption point data from the permanent storage area for use to determine the disruption point in the previous rebuild procedure that has been disrupted; and
a rebuilding module, which is capable of performing a resumed rebuilding procedure on the rebuilding disk in the disk array unit that starts from the disruption point in the previous rebuild procedure.

7. The disk array rebuild disruption resumption handling system of claim 6, wherein the disk array unit is a RAID (Redundant Array of Independent Disks) unit.

8. The disk array rebuild disruption resumption handling system of claim 6, wherein the specified permanent storage utilized by the disruption point recording module for storing disruption point data is a superblock on an unfailed disk on the disk array unit.

9. The disk array rebuild disruption resumption handling system of claim 6, wherein the disruption point data recorded by the disruption point recording module includes an index number of the last block that has completed rebuilding in the previous rebuild procedure.

10. The disk array rebuild disruption resumption handling system of claim 6, wherein the resumed rebuilding procedure performed by the rebuilding module includes an initial step of cache and write buffer status checking procedure that checks whether the cache memory and write buffer operating status on the disk array unit is currently under active operating status; and if YES, the cache memory and the write buffer are temporarily disabled; and after the rebuild procedure on the backup disk is completed, the cache and write buffer status is reset to the previous active operating status.
